(19) United States
(12) Patent Application Publication
(10) Pub. No.: US 2015/0266788 A1
(43) Pub. Date: Sep. 24, 2015

(54) ORGANIC FERTILIZER COMPOSITION FROM CAMELLIA SINENSIS EXTRACT FOR PEST CONTROL AND A METHOD OF SYNTHESIZING THE SAME

(71) Applicants: Vahid Shatermashhadi, Tehran (IR); Babak Manafi, Tehran (IR); Karen Abrinia, Karaj (IR)

(72) Inventors: Vahid Shatermashhadi, Tehran (IR); Babak Manafi, Tehran (IR); Karen Abrinia, Karaj (IR)

(21) Appl. No.: 14/732,751

(22) Filed: Jun. 7, 2015

(51) Int. Cl. C05G 3/02; A01N 65/08; C05F 11/00

(52) U.S. Cl. CPC C05G 3/02; C05F 11/00; A01N 65/08

(57) ABSTRACT

The embodiments herein provide an organic fertilizer based on aquatic extraction of Camellia sinensis with sodium sorbate as preservative. The organic, herbal fertilizer also acts as pesticide against the pest arthropodic species. The application of herbal fertilizer composition is environmental friendly. Further the fertilizer is applied in soil and hydrophonic systems. The fertilizer is absorbed by plant roots. The fertilizer induces systemic resistance to destructive pests for example spider mites and whiteflies. The organic fertilizer is synthesized by aquatic extraction method. The method comprises boiling 6 gram Camellia sinensis leaves in 1 liter water for 95° C. for 15 minutes, obtaining the extract, filtering the extract for removing Camellia sinensis leaves, and adding sodium sorbate at a concentration of 0.01 gram/liter as a preservative to the extract to obtain a bio-fertilizer.

### SPONSORSHIP STATEMENT

This application is financially sponsored for international filing by the IRANIAN NATIONAL SCIENCE FOUNDATION (INSF).

### BACKGROUND

1. Technical Field

The embodiments herein generally relate to the field of agriculture. The embodiment herein particularly relate to biopesticide and biofertilizer. The embodiments herein more particularly relate to an herbal extract for organic fertilizer and organic pesticide. The embodiment herein also relate to an extract of Camellia sinensis for organic fertilizer and organic pesticide.

2. Description of the Related Art

Agricultural crop loss or plant loss is caused by pests and pathogens such as microbes and insects. A pest is defined as an organism detrimental to agriculture and crop production. The other meaning is an organism which causes damage and epidemic disease associated with high mortality. The common insect pests which damage plants and crops are spider mite, white flies, molluscs etc. The crop loss or plant loss is significant to plant based agriculture and industries and to domestic gardening. The losses may arise through spoilage of produce both pre and post harvest, loss of plants themselves or through reduction in growth and production abilities.

Traditionally large scale control of plant pests and pathogen has been perused through the application of chemical insecticide through physical methods (example: trapping, picking, barriers) may be employed. The use of chemicals is subjected to a number of disadvantages including environment pollution, bioaccumulation etc. In recent times, the plant pests and pathogens have developed resistance or tolerance to chemical pesticide. Further, these resistant pests produce chemical resistant population. For example, snails have developed resistance to some pesticide such as synthetic chemicals metaldehyde and methiocarb. Resistance to pesticide is the greatest challenge to the viability of plant based agriculture and industries such as the horticulture industry.

The chemical residues in the form of fertilizers or pesticide also pose environmental hazards and raise health concerns. The revival of interest in biological control such as microbial insecticide over the last 20 years has come directly from public pressure in response to concerns about chemical toxicities. A biological control presents an alternative means of controlling plant pathogens which are potentially more effective and specific than current methods as well as reducing dependence on chemicals. Such biological control methods are perceived as “natural” alternatives to chemical insecticides with the advantages of greater public acceptance reduced environmental contamination and increased sustainability.

The mechanisms of biological control are diverse. One mechanism which has been demonstrated to be effective is the use of antagonistic microorganisms such as bacteria to control insects. But the use of microorganism poses threat to the users and may cause infections or health hazards if not handled properly.

A new and effective technology which has improved agricultural output is greenhouse technology. The greenhouse technology has improved productivity, profitability and sustainability of farming systems. The main advantage of the greenhouse is efficient utilization of chemicals, pesticides to control pest and disease.

A greenhouse is a building or complex in which plants are grown. These structures range in size from small sheds to industrial sized buildings. A miniature greenhouse is known as a cold frame. The greenhouse has the following equipments i.e. screening, installation, heating, cooling, and lighting.

Greenhouse allows for greater control over the growing environment of plants depending upon the technical specification of a greenhouse. The key factors which are controlled included temperature levels of light and shade, irrigation, fertilizer application and atmospheric humidity. Greenhouses are used to overcome shortcoming in the growing qualities of a pieces of land such as short growing qualities of a pieces of land such as short growing season or poor light levels and they can thereby improve food production in marginal environments. Greenhouses are often used for growing flowers, vegetables, fruits and transplant.

Greenhouse allows greater control over the cultivation environment of plants depending upon the technical specification of a greenhouse.

Greenhouses are becoming increasingly important in crop production in the world, especially in the production of vegetables, fruit crops and ornamental plants. Greenhouse gardening is similar in many ways to gardening outside in open fields. But the plants still need adequate nutrients, water and protection from arthropod pests and diseases.

The growth rate of greenhouse plants is high and the growth requirements are provided by comprehensive nutrition and fertilization.

The term “fertilization” includes the addition of elements or other materials to the soil to increase or maintain plant yields. Fertilizers are classified mainly into two categories i.e. inorganic fertilizers and organic fertilizers.

Fertilizers are placed into the categories of organic and chemical fertilizers (compound of simple chemicals and minerals). Organic fertilizers are naturally occurring compounds manufactured through natural processes. Chemical fertilizers are manufactured through chemical processes using naturally occurring deposits, while chemically altering them.

The uses of chemical fertilizers have numerous limitations. for example, chemical fertilizers tend to release many chemicals elements that are not easily biodegradable into the soil. These chemicals contaminate environment.

For the production of chemical fertilizers, huge amounts of energy is required. Also the fertilizers are rich in synthetic chemical elements. The long term application of the fertilizer causes soil dehydration and destruction of plant tissue and kills the soil microorganism. The chemicals from the fertilizer accumulate in the soil, altering soil pH and chemistry. It has been reported that long term application of fertilizer has made soil un-cultivable. The excessive chemical elements can bind to other natural nutrients in the soil making the nutrients unavailable to plants. The longer and the more chemical fertilizers are applied the higher the quantity of fertilizers is required for the succeeding cultivation period.

The chemical elements are in ready to use form, when they are mixed in the soil the nutrients are immediately absorbed by the roots. Further the excessive elements than necessary cause the roots and plants to burn up.

The overdose of chemicals kills helpful microbes and leak excessive elements out to the soil. This pollutes the soil and underground water. This makes the soil completely dependent on the fertilizer.

When the soil pH and chemistry is altered by the chemical fertilizer, then soil dries up. This leads to caking and hardening Caking and hardening makes the soil unfit for cultivation. It has been reported that the soil turns acidic.

The inorganic fertilizers comprise synthetic artificial ingredients manufactured and ready to use on plants. The chemical and minerals deposit are often used for the synthesis of inorganic fertilizer. The main disadvantage of the inorganic fertilizer are plant damage, leaching, salt accumulation, environmental pollution, high cost etc. The incorrect amount and method of applying inorganic fertilizer damage plants/crops. The inorganic fertilizer causes leaf damage, scorching, decrease in growth and plant death. “Leaching” is the term used, when inorganic fertilizers leach away from the root zone of the plants. The inorganic fertilizer leaches away into the soil below the root system of plant. The inorganic fertilizer accumulates in soil, causing the pH change in the soil. The inorganic fertilizer causes environmental pollution. The inorganic fertilizer reaches groundwater and also gets washed away to the water bodies. The main drawback of the inorganic fertilizer is the high cost. The inorganic fertilizer has high manufacturing cost.

The organic fertilizers are usually manures and organic waste materials which provide growth elements and also serve as conditioners for soil. Organic fertilizers are fertilizer derived from animal matter, human excrets, plant waste or compost. The organic fertilizer makes the crops and the food crops chemical free. The organic fertilizer is prepared locally in farm or any land with vegetable waste, farm waste, crop waste, animal waste. Hence the cost of organic fertilizer is less. The organic fertilizer ensures that the soil remains fertile because the organic fertilizers are biodegradable. The organic fertilizers are easily bio-degradable and do not cause environmental pollution.

The greenhouses are maintained under relatively stable environmental conditions for optimal growth of plants. Unfortunately the conditions in the greenhouse also favor the rapid growth of pests, especially small pests such as mites, whiteflies and aphids which develop rapidly and can increase their population quickly over a short period before notice by growers. Culture methods commonly adopted in greenhouses also encourage pest development. The crops are often cultivated in monoculture in greenhouses, which facilitates the dispersal of pests among plants and rapid development of pest populations. The lack of natural enemies in the enclosed artificial environment and the rapid development of pesticide resistance in greenhouses are also important factors for the pest status of plant pests.

Pesticides are important in managing greenhouse pests. However the application of pesticides in enclosed spaces increases the risk of worker exposure. In poorly ventilated areas, danger of pesticide exposure by inhalation is greatly increased. Phytotoxicity, injury to plants by the pesticide, is also a greater concern in an enclosed environment. Plants growing rapidly in the greenhouse are more succulent and thus more susceptible to pesticide phytotoxicity. Pesticide residues in greenhouse crops are another limitation of chemical control. The residues have harmful effects on human body and caused dangerous diseases such as various cancers. Pest resistance, secondary pest replacement and killing of non-target organism are other side effects of chemical pesticide applications.

Plants resistance to insects is one of several cultural control methods. Cultural control methods involve use of agronomic practices to reduce insect pest abundance and damage below that which would have occurred if the practice had not been used. In integrated pest management strategies (IPM), plant resistance to insects refers to the use of resistant crop varieties to suppress insect pest damage. Plant resistance is intended to be used in conjugation with other direct control tactics.

Induced resistance means the enablement of resistance in plants that are otherwise susceptible, in response to an extrinsic stimulus without alterations of the genome. The inducing agents are of biotic or abiotic nature.

Role of plant extracts in inducing resistance against plant pathogens and pests has been reported by different researchers. Tea is recommended and used in both Chinese and Indian traditional medicine for many centuries. Recently clinical studies have documented the human health benefits of tea, especially for its role as a cancer preventing and fighting anti-oxidant.

Extracts of green tea are primarily composed of low molecular weight organic compounds. The tea extracts consist of alkaloids, tannins, quinines, coumarin, phenolic compound, caffeine, polyphenols and phytoalexins which are known for pesticidal activity. These polyphenols including the catechin group have been found to have various physiological effects on both the individual and the cellular level. The oxidation process transforms the polyphenols into a wider range of compounds inducing the theaflavin and thearubigin.

Hence there is a need for biochemical extracts and methods for effectively controlling pests. Also there is a need for herbal extract and composition which act faster, have increased efficacy in controlling pests, requires less frequent and less intensive application and has a low cost. Further there is a need for a plant extract which acts both as fertilizer and pesticide. Further there is a need for an easy method for synthesizing herbal extracts which act both as pesticide and fertilizer.

The above mentioned shortcomings, disadvantages and problems are addressed herein and which will be understood by reading and studying the following specification.

### OBJECTIVES OF THE EMBODIMENTS

The primary objective of the embodiment herein is to synthesize an organic fertilizer composition from Camellia sinensis extract.

Another object of the embodiment herein is to synthesize an organic fertilizer composition from Camellia sinensis extract which also act as pest controlling agent or pesticide.

Yet another object of the embodiment herein is to provide an herbal extract which functions both as fertilizer and pesticide which has no adverse effect of the plants or crops.

Yet another object of the embodiment herein is to provide a simple and easy method for synthesis of herbal extract composition from Camellia sinensis.

Yet another object of the embodiment herein is to provide a herbal fertilizer composition and a herbal pesticide composition which require less frequent and less intensive application.

Yet another object of the embodiment herein is to provide a herbal fertilizer composition and a herbal pesticide composition which do not pollute environment.

Yet another object of the embodiment herein is to provide a herbal fertilizer composition and a herbal pesticide composition which do not enter food chain and do not cause bioaccumulation.

Yet another object of the embodiment herein is to provide a herbal pesticide composition for protecting plant crops from insect pests particularly arthropod pest species.

Yet another object of the embodiment herein is to provide a herbal fertilizer composition which is also applied with irrigation water or hydroponics system.

Yet another object of the embodiment herein is to provide a herbal fertilizer composition which is applied directly both in soil and hydroponic system of a greenhouse system.

These objects and the other advantages of the embodiments herein will become readily apparent from the following detailed description taken in conjunction with the accompanying drawings.

### SUMMARY

The various embodiments herein provide an organic fertilizer based on aquatic extraction of Camellia sinensis with sodium sorbate as preservative. The organic, herbal fertilizer also acts as pesticide against the pest arthropod species. The application of herbal fertilizer composition is environmental friendly. Further the fertilizer is applied in soil and hydrophonic systems. The fertilizer is absorbed by plant roots. The fertilizer induces systemic resistance to destructive pests for example spider mites and whiteflies.

According to an embodiment herein, a method is provided for synthesizing organic bio-fertilizer from Camellia sinensis leaves by aquatic extraction method. The method comprises the steps of collecting or acquiring dried leaves of Camellia sinensis; boiling a preset quantity of the dried leaves of Camellia sinensis in a preset quantity water; acquiring the Camellia sinensis leaf extract; filtering the leaf extract for removing Camellia sinensis leaves; and adding a sodium sorbate in a pre-set quantity to the extract to obtain a bio-fertilizer.

According to an embodiment herein, the quantity of the dried leaves is 6 grams, and the dry leaves are boiled at a temperature of 95° C. for 15 minutes.

According to an embodiment herein, the pre-set quantity of sodium sorbate added is in a range of 0.01-1 gram/liter, and the bio-fertilizer is applied to plants or crops by a plurality of methods.

According to an embodiment herein, the sodium sorbate is a preservative.

According to an embodiment herein, a concentration of an active ingredient in Camellia sinensis leaf extract is 6 ppm.

According to an embodiment herein, the plurality of methods is selected from a group consisting of mixing the bio-fertilizer with irrigation water, direct application of the bio-fertilizer in soil, mixing of bio-fertilizer in a hydroponics system of greenhouse and spraying bio-fertilizer on plants/crops.

According to an embodiment herein, the bio-fertilizer induces pest resistance, and the bio-fertilizer is safe for human health. The bio-fertilizer does not pollute an environment, and the bio-fertilizer does not cause damage to host plant or crops.

According to an embodiment herein, the bio-fertilizer increases a vegetative growth in plants or crops by 2 times.

According to an embodiment herein, wherein the bio-fertilizer increases a reproductive growth in plants or crops by 1.52 times.

According to an embodiment herein, the bio-fertilizer induces a pest resistance in plants, and the plants become resistant to a plurality of arthropod pests. The arthropod pests are a whitefly and a spider mite. A population density of the whitefly after an application of bio-fertilizer is reduced by 75%, and a population density of the spider mite after an application of bio-fertilizer is reduced by 25%.

According to an embodiment herein, the bio-fertilizer is applied to plants in every 72 hours.

According to an embodiment herein, an organic bio-fertilizer composition synthesized from Camellia sinensis leaves is provided. The composition comprises a Camellia sinensis leaf extract; and a sodium sorbate. The sodium sorbate is added in a preset quantity to the extract to obtain a bio-fertilizer. The pre-set quantity of sodium sorbate added to the extract is within a range of 0.01-1 gram/liter, and the bio-fertilizer is applied to plants or crops by a plurality of methods.

According to an embodiment herein, the sodium sorbate is a preservative.

According to an embodiment herein, a concentration of an active ingredient in Camellia sinensis leaf extract is 6 ppm.

According to an embodiment herein, the plurality of methods is selected from a group consisting of mixing the bio-fertilizer with irrigation water, direct application of the bio-fertilizer in soil, mixing of bio-fertilizer in a hydroponics system of greenhouse and spraying bio-fertilizer on plants/crops.

According to an embodiment herein, the bio-fertilizer induces pest resistance, and the bio-fertilizer is safe for human health. The bio-fertilizer does not pollute an environment, and the bio-fertilizer does not cause damage to host plant or crops.

According to an embodiment herein, the bio-fertilizer increases a vegetative growth in plants or crops by 2 times.

According to an embodiment herein, the bio-fertilizer increases a reproductive growth in plants or crops by 1.52 times.

According to an embodiment herein, the bio-fertilizer induces a pest resistance in plants, and the plants become resistant to a plurality of arthropod pests. The arthropods pests are a whitefly and a spider mite, and a population density of the whitefly after an application of bio-fertilizer is reduced by 75%. A population density of the spider mite after an application of bio-fertilizer is reduced by 25%.

According to an embodiment herein, the bio-fertilizer is applied to plants in every 72 hours.

According to one embodiment herein, the embodiment herein provides an organic fertilizer. The organic fertilizer is synthesized from Camellia sinensis leaves. The organic fertilizer is synthesized by aquatic extraction method. In the aquatic extraction method 6 gram of dried Camellia sinensis leaves are boiled in 1 Liter of water at 95° C. for 15 minutes. After boiling the extract is obtained. The extract is filtered to remove the Camellia sinensis leaves. To the extract/filtrate the sodium sorbate is added as a preservative. The extract has the concentration of 6 ppm.

According to one embodiment herein, the organic fertilizer is synthesized by aquatic extraction method of Camellia sinensis leaves with sodium sorbate (0.01 gram/liter) as preservative.

According to one embodiment herein, the organic fertilizer is applied in greenhouse plants such as vegetables and ornamental plants. The organic fertilizer is absorbed by plant roots. A systematic effect of the fertilizer is observed in foliage parts of treated plants.

According to one embodiment herein, for desirable effects 20 ml of the organic fertilizer is applied per plant every 72 hours.

According to one embodiment herein, the effect of organic fertilizer is investigated on plants and crops. The organic fertilizer exhibits that the vegetative and reproductive growth of the plants increases. The organic fertilizer also impacts plant pest resistance. After the application of organic fertilizer the plants become resistance to arthropod insects. Specifically to spider mite, whiteflies. The organic fertilizer induces systematic resistance to destructive greenhouse pests such as spider mites and whiteflies.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a flowchart indicating a method for synthesizing the bio-fertilizer from the Camellia sinensis leaves by aquatic extraction method, according to an embodiment herein.

Although the specific features of the embodiments herein are shown in some drawings and not in others. This is done for convenience only as each feature may be combined with any or all of the other features in accordance with the embodiments herein.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### DETAILED DESCRIPTION OF THE EMBODIMENTS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide an organic fertilizer based on aquatic extraction of Camellia sinensis with sodium sorbate as preservative. The organic, herbal fertilizer also acts as pesticide against the pest arthropodic species. The application of herbal fertilizer composition is environmental friendly. Further the fertilizer is applied in soil and hydrophonic systems. The fertilizer is absorbed by plant roots. The fertilizer induces systemic resistance to destructive pests for example spider mites and whiteflies.

According to an embodiment herein, a method is provided for synthesizing organic bio-fertilizer from Camellia sinensis leaves by aquatic extraction method. The method comprises the steps of collecting or acquiring dried leaves of Camellia sinensis; boiling a preset quantity of the dried leaves of Camellia sinensis in a preset quantity water; acquiring the Camellia sinensis leaf extract; filtering the leaf extract for removing Camellia sinensis leaves; and adding a sodium sorbate in a pre-set quantity to the extract to obtain a bio-fertilizer.

According to an embodiment herein, the quantity of the dried leaves is 6 grams, and the dry leaves are boiled at a temperature of 95° C. for 15 minutes.

According to an embodiment herein, the pre-set quantity of sodium sorbate added is in a range of 0.01-1 gram/liter, and the bio-fertilizer is applied to plants or crops by a plurality of methods.

According to an embodiment herein, the sodium sorbate is a preservative.

According to an embodiment herein, a concentration of an active ingredient in Camellia sinensis leaf extract is 6 ppm.

According to an embodiment herein, the plurality of methods is selected from a group consisting of mixing the bio-fertilizer with irrigation water, direct application of the bio-fertilizer in soil, mixing of bio-fertilizer in a hydroponics system of greenhouse and spraying bio-fertilizer on plants/crops.

According to an embodiment herein, the bio-fertilizer induces pest resistance, and the bio-fertilizer is safe for human health. The bio-fertilizer does not pollute an environment, and the bio-fertilizer does not cause damage to host plant or crops.

According to an embodiment herein, the bio-fertilizer increases a vegetative growth in plants or crops by 2 times.

According to an embodiment herein, wherein the bio-fertilizer increases a reproductive growth in plants or crops by 1.52 times.

According to an embodiment herein, the bio-fertilizer induces a pest resistance in plants, and the plants become resistant to a plurality of arthropod pests. The arthropod pests are a whitefly and a spider mite. A population density of the whitefly after an application of bio-fertilizer is reduced by 75%, and a population density of the spider mite after an application of bio-fertilizer is reduced by 25%.

According to an embodiment herein, the bio-fertilizer is applied to plants in every 72 hours.

According to an embodiment herein, an organic bio-fertilizer composition synthesized from Camellia sinensis leaves is provided. The composition comprises a Camellia sinensis leaf extract; and a sodium sorbate. The sodium sorbate is added in a preset quantity to the extract to obtain a bio-fertilizer. The pre-set quantity of sodium sorbate added to the extract is within a range of 0.01-1 gram/liter, and the bio-fertilizer is applied to plants or crops by a plurality of methods.

According to an embodiment herein, the sodium sorbate is a preservative.

According to an embodiment herein, a concentration of an active ingredient in Camellia sinensis leaf extract is 6 ppm.

According to an embodiment herein, the plurality of methods is selected from a group consisting of mixing the bio-fertilizer with irrigation water, direct application of the bio-fertilizer in soil, mixing of bio-fertilizer in a hydroponics system of greenhouse and spraying bio-fertilizer on plants/crops.

According to an embodiment herein, the bio-fertilizer induces pest resistance, and the bio-fertilizer is safe for human health. The bio-fertilizer does not pollute an environment, and the bio-fertilizer does not cause damage to host plant or crops.

According to an embodiment herein, the bio-fertilizer increases a vegetative growth in plants or crops by 2 times.

According to an embodiment herein, the bio-fertilizer increases a reproductive growth in plants or crops by 1.52 times.

According to an embodiment herein, the bio-fertilizer induces a pest resistance in plants, and the plants become resistant to a plurality of arthropod pests. The arthropods pests are a whitefly and a spider mite, and a population density of the whitefly after an application of bio-fertilizer is reduced by 75%. A population density of the spider mite after an application of bio-fertilizer is reduced by 25%.

According to an embodiment herein, the bio-fertilizer is applied to plants in every 72 hours.

According to one embodiment herein, the embodiment herein provides an organic fertilizer. The organic fertilizer is synthesized from Camellia sinensis leaves. The organic fertilizer is synthesized by aquatic extraction method. In the aquatic extraction method 6 gram of dried Camellia sinensis leaves are boiled in 1 Liter of water at 95° C. for 15 minutes. After boiling the extract is obtained. The extract is filtered to remove the Camellia sinensis leaves. To the extract/filtrate the sodium sorbate is added as a preservative. The extract has the concentration of 6 ppm.

According to one embodiment herein, the organic fertilizer is synthesized by aquatic extraction method of Camellia sinensis leaves with sodium sorbate (0.01 gram/liter) as preservative.

According to one embodiment herein, the organic fertilizer is applied in greenhouse plants such as vegetables and ornamental plants. The organic fertilizer is absorbed by plant roots. A systematic effect of the fertilizer is observed in foliage parts of treated plants.

According to one embodiment herein, for desirable effects 20 ml of the organic fertilizer is applied per plant every 72 hours.

According to one embodiment herein, the effect of organic fertilizer is investigated on plants and crops. The organic fertilizer exhibits that the vegetative and reproductive growth of the plants increases. The organic fertilizer also impacts plant pest resistance. After the application of organic fertilizer the plants become resistance to arthropod insects. Specifically to spidermite, whiteflies. The organic fertilizer induces systematic resistance to destructive greenhouse pests such as spider mites and whiteflies.

The population densities of whiteflies and spider mites in treated plants with the fertilizer are 75% and 25% lower than the control plants. The control plants are not treated with fertilizer.

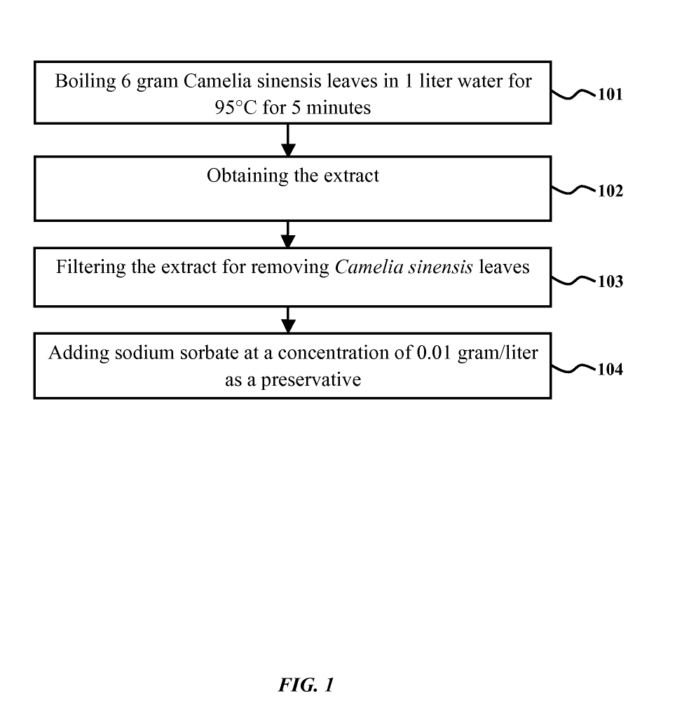

FIG. 1 illustrates a flowchart indicating a method for synthesizing the bio-fertilizer from the Camellia sinensis leaves by aquatic extraction method, according to an embodiment herein. With respect to FIG. 1, the first step is boiling 6 gram Camellia sinensis leaves in 1 liter water for 95° C. for 15 minutes (101). The second step is obtaining the extract (102). The third step is filtering the extract for removing Camellia sinensis leaves (103). The last step is adding sodium sorbate at a concentration of 0.01 gram/liter as a preservative (104).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A method of synthesizing organic bio-fertilizer from Camellia sinensis leaves by aquatic extraction method, the method comprises the steps of:
collecting or acquiring dried leaves of Camellia sinensis;
boiling a preset quantity of the dried leaves of Camellia sinensis in a preset quantity water, and wherein the quantity of the dried leaves is 6 grams, and wherein the dry leaves are boiled at a temperature of 95° C. for 15 minutes;
acquiring the Camellia sinensis leaf extract;
filtering the leaf extract for removing Camellia sinensis leaves; and
adding a sodium sorbate in a pre-set quantity to the extract to obtain a bio-fertilizer, and wherein the pre-set quantity of sodium sorbate added is in a range of 0.01-1 gram/liter, and wherein the bio-fertilizer is applied to plants or crops by a plurality of methods.

2. The method according to claim 1, wherein the sodium sorbate is a preservative.

3. The method according to claim 1, wherein a concentration of an active ingredient in Camellia sinensis leaf extract is 6 ppm.

4. The method according to claim 1, wherein the plurality of methods is selected from a group consisting of mixing the bio-fertilizer with irrigation water, direct application of the bio-fertilizer in soil, mixing of bio-fertilizer in a hydroponics system of greenhouse and spraying bio-fertilizer on plants/crops.

5. The method according to claim 1, wherein the bio-fertilizer induces pest resistance, and wherein the bio-fertilizer is safe for human health, and wherein the bio-fertilizer does not pollute an environment, and wherein the bio-fertilizer does not cause damage to host plant or crops.

6. The method according to claim 1, wherein the bio-fertilizer increases a vegetative growth in plants or crops by 2 times.

7. The method according to claim 1, wherein the bio-fertilizer increases a reproductive growth in plants or crops by 1.52 times.

8. The method according to claim 1, wherein the bio-fertilizer induces a pest resistance in plants, and wherein the plants become resistant to a plurality of arthropod pests, and wherein the arthropods are a whitefly and a spider mite, and wherein a population density of the whitefly after an application of bio-fertilizer is reduced by 75%, and wherein a population density of the spider mite after an application of bio-fertilizer is reduced by 25%.

9. The method according to claim 1, wherein the bio-fertilizer is applied to plants in every 72 hours.

10. An organic bio-fertilizer composition from Camellia sinensis leaves the composition comprises:
a Camellia sinensis leaf extract; and
a sodium sorbate, and wherein the sodium sorbate is added in a preset quantity to the extract, and wherein the pre-set quantity of sodium sorbate added to the extract is within a range of 0.01-1 gram/liter, and wherein the bio-fertilizer is applied to plants or crops by a plurality of methods.

11. The composition according to claim 11, wherein the sodium sorbate is a preservative.

12. The composition according to claim 11, wherein a concentration of an active ingredient in Camellia sinensis leaf extract is 6 ppm.

13. The composition according to claim 11, wherein the plurality of methods is selected from a group consisting of mixing the bio-fertilizer with irrigation water, direct application of the bio-fertilizer in soil, mixing of bio-fertilizer in a hydroponics system of greenhouse and spraying bio-fertilizer on plants/crops.

14. The composition according to claim 11, wherein the bio-fertilizer induces pest resistance, and wherein the bio-fertilizer is safe for human health, and wherein the bio-fertilizer does not pollute an environment, and wherein the bio-fertilizer does not cause damage to host plant or crops.

15. The composition according to claim 11, wherein the bio-fertilizer increases a vegetative growth in plants or crops by 2 times.

16. The composition according to claim 11, wherein the bio-fertilizer increases a reproductive growth in plants or crops by 1.52 times.

17. The composition according to claim 11, wherein the bio-fertilizer induces a pest resistance in plants, and wherein the plants become resistant to a plurality of arthropod pests, and wherein the arthropods are a whitefly and a spider mite, and wherein a population density of the whitefly after an application of bio-fertilizer is reduced by 75%, and wherein a population density of the spider mite after an application of bio-fertilizer is reduced by 25%.

18. The composition according to claim 11, wherein the bio-fertilizer is applied to plants in every 72 hours.
